(19) United States
(12) Patent Application Publication
(10) Pub. No.: US 2004/0101723 A1
(43) Pub. Date: May 27, 2004

(54) Portable elektrochemical oxygen generator

(76) Inventors: Rainer Kruppa, Greifswald (DE); Bernd Rohland, Berlin (DE); Hansgeorg Schuldzig, Jork (DE); Frank Adolf, St. Georgsfeld (DE); Barbara Roth, Greifswald (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/415,311

(22) PCT Filed: Oct. 26, 2001
(86) PCT No.: PCT/DE01/04083

(30) Foreign Application Priority Data
Oct. 27, 2000 (DE) 10053546.1

(51) Int. Cl. H01M 8/04; H01M 8/10; H01M 4/92; H01M 4/96

(52) U.S. Cl. 429/22; 429/24; 429/30; 429/40; 429/44; 429/32; 429/13

(57) ABSTRACT

The invention relates to a portable electrochemical oxygen generator, comprising: a proton-conducting polymer electrolyte membrane (PEM) (1); a water-filled, porous anode (2), with an anode chamber (6); a porous air cathode (3), with a cathode chamber (5), whereby the PEM, anode and cathode form a PEM-cell; a direct current source (4); a cathode gas condensate separator (7), connected to the anode chamber by means of a condensate line and a pump (8), to form a water-cooling circuit; a reservoir with reducing valve (9) for the oxygen generated and a controller/regulator unit (11), for the control/regulation of the oxygen generation, the air feed and the temperature of the PEM-cell.

The invention relates to a portable electrochemical oxygen generator for the noiseless production of oxygen from air by means of electric power in an electrochemical cell, as well as a process for the production of oxygen using the oxygen generator.

### STATE OF THE ART

It is known that oxygen can be obtained from air by distilling liquid air in fractions. This relates to an industrial, stationary procedure.

Further it is known that one can enrich oxygen in air up to 50%, by pressure-change-adsorption binding the nitrogen of the air in molecular sieves. Here one needs a vacuum pump and a vacuum valve control technology.

Further it is known that one can obtain oxygen from air by electrochemical “pumping” by means of a gas-tight ceramic oxide ion conducting diaphragm heated up to 800° C. The disadvantage exists in the warmup time of the ceramic diaphragm and its break sensitivity.

It is also known that one can produce pure oxygen and hydrogen by water electrolysis. In the Zdansky Lonza process distilled water containing KOH is split at a pressure of 30 bar with 6,600 A. Here, the disadvantage is the high electric power consumption for the oxygen, if the hydrogen is a waste product, as it is e.g. with a portable oxygen generator for medical technology.

### OBJECT OF THE INVENTION

It is the object of the invention to provide both a device and a process to for the production of oxygen which overcome the disadvantages of the state of the art and which in particular allow producing pure oxygen suitable for medical technology by means of a portable device.

### SUMMARY OF THE INVENTION

According to the invention this object is achieved by a portable electrochemical oxygen generator according to claim 1 and a process for the production of oxygen according to claim 5. Advantageous and preferred embodiments of the claimed invention are specified in the sub-claims.

Thus, the invention is a portable electro-chemical oxygen generator compromising:

a proton-conducting polymer electrolyte diaphragm (PEM),

a water-filled porous anode with an anode chamber,

a porous air cathode with a cathode chamber, the PEM, the anode, and the cathode forming a PEM cell,

a DC power supply

a cathode gas condensate separator, which is connected to the anode chamber via a condensate line and a pump to form a water cooling cycle,

a reservoir with a reduction valve for the produced oxygen, and

a controller/regulator unit for the control/regulation of the oxygen generation, air supply and temperature of the PEM cell.

### DETAILED DESCRIPTION OF THE INVENTION

According to the invention it has been shown that it is possible to produce pure oxygen with the aid of an electro-chemical cell by means of electric current from air at temperatures from 20 to 70° C. without a warm up period and without electro-chemical pumping as well as without the high energy consumption of water electrolysis, the produced pure oxygen not only being suitable for technical but particularly for medical purposes.

The electrochemical cell is a PEM cell having a structure that is known from fuel cells. As for the anode, metals of the platinum group are particularly suitable, Iridium being preferred. As for the cathode, a platinum group metal/carbon compound is suitable, platinum being preferred as the platinum group metal (Pt—C).

Preferably, several PEM cells are stacked and joined to a stack regarding the gas and water flow as well as the electric current guidance, the stacking being done in such a way that the cells are in electric contact using bi-polar plates and the anode chamber and cathode chamber are sealed against each other by means of gaskets. The stacking takes place in a simple way by pressing individual cells using end plates and bolts/nuts.

The process according to the invention for the production of oxygen by means of an oxygen generator according to the invention comprises the following steps of:

supplying/removing air to/from the cathode chambers of the PEM cell or the PEM stack,

withdrawing and removing produced oxygen from the anode chambers,

regulating the electric current through the PEM cell or the PEM stack with the pressure drop upon oxygen withdrawal by means of a programmable controller,

condensing water vapor out of the exhaust air from the cathode chambers of the PEM cell or the PEM stack, and

pumping the water vapor condensate after cooling, and supplying this condensate to the anode chamber of the PEM cell or the PEM stack.

With electric current at the electrodes and in the PEM cell the following reactions take place:

Anode: H₂0₁⇄½ 0₂(pure)+2 H⁺ (diaphragm)+2e⁻ (anode)

Cathode: ½ 0₂(air)+2H⁺ (diaphragm)+2e⁻ (cathode)⇄H₂0₁

Electric circuit:: 2e⁻ (anode)→2e⁻ (cathode)

Cell: ½ 0₂(air)⇄½ 0₂(pure)

According to the invention, the PEM cell which applies the process according to the invention mainly consists of a proton-conducting diaphragm, an anode filled with liquid water at which gaseous oxygen is generated and water is consumed, and an air cathode at which atmospheric oxygen is consumed and condensing water is generated, which is condensed and supplied to the anode. Anodic water consumption and cathodic water production are in the same amount, here.

The electric current through the PEM cell is generated in that a low cell voltage corresponding to the process of the invention of, for example, 0.8V is applied to the cell, which only has to overcome the electrolyte resistance of the diaphragm and the polarization resistance mainly of the air cathode, so that the high electric power consuming water electrolysis is avoided, because the equilibrium cell voltage of the PEM cell is only 0.02V for 0₂/air opposite to 1.22V for the 0₂/H₂ cell, whereby the energy consumption goes down to less than approx. 50% of water electrolysis.

According to the invention the regulation of the oxygen production is controlled by the pressure in the anode chamber, which sinks, when oxygen is taken from the generator. According to the invention the pressure deviation from the target pressure controls the electric current, which causes oxygen generation until the target pressure in the anode chamber is reached again, which is preferably held at 0.4 bar.

### EMBODIMENT EXAMPLE

### The invention is described in detail with reference to the drawing in which

FIG. 1 shows a schematic representation of a preferred embodiment of an oxygen generator according to the invention.

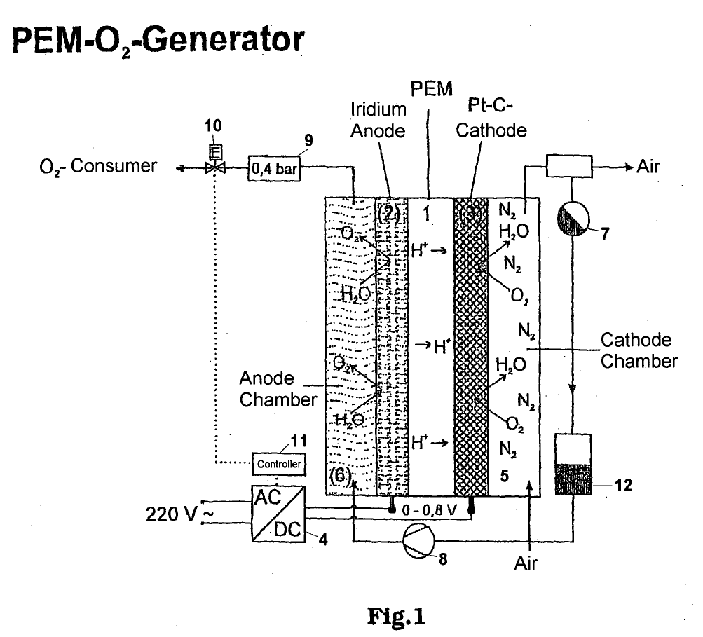

In a preferred Embodiment the oxygen generator according to the invention comprises a pile of ten PEM cells, which are assembled into a PEM-0₂-stack in such a way that the water-filled anodes 2 are each in pressing contact with a gas-tight bi-polar plate and the air-cathode 3 of the next cell. Channels in gasket frames sealing the anode and cathode chambers against each other are providing the common O₂ and air supply for all PEM cells. To the channels, the cathodes have a supply and a discharge connections, the anodes have a O₂ discharge as well as a H₂O supply connection to the common H₂O channel which is fed by a pump 8, preferably a diaphragm pump, with H₂O condensate out of the condenser 7 of the cathode process water, thus forming a cooling water circuit. This allows keeping the oxygen generator at the desired operating temperature.

Corrosion resistant porous metal sponge plates are inserted into the anode chambers 6 and graphite felt with stamped so-called “flow fields” for air are inserted into the cathode chambers for ensuring the electrical contact of all PEM electrodes. The stack is enclosed by two end plates and two electric current conducting plates with external bolts and nuts in such a way that a homogeneous electrical contact of all cells with each other is provided and that the pressure force is sufficient for sealing the anode and cathode chambers by means of the gasket frames. 0.2 mm up to 0.5 mm strong compensation metal sheets may be inserted centrally between the end plates and the current guiding plates in order to compensate the small elastic deformation of the end plates arising upon tightening the nuts.

In the preferred embodiment of the PEM-O₂-Stack, the process according to the invention upon application of a DC voltage from the DC supply 4 of 8.0V and a current of 40 A produces, for example, 100 NI/h pure oxygen and thereby reduces the oxygen content of the supplied 1000 NI/h air down to 10%. In this course 150 ml/h H₂0 collected in the cathode air condensate separator 7 are to be pumped into the common H₂0-channel by means of the diaphragm pump 8 and thus into the anode chambers 6 of the PEM-0₂-stack. A refill container 12 containing de-ionised H₂0, which is integrated into the condensate line upstream of the diaphragm pump, serves for compensating 10 to 20% H₂O loss with the exhaust air.

1. A portable electro-chemical oxygen generator including:
a proton-guiding polymer electrolyte diaphragm (PEM) (1),
a water-filled, porous anode (2) with an anode chamber (6),
a porous air cathode (3) with a cathode chamber (5), the PEM, the anode and the cathode forming a PEM cell,
a DC supply (4),
a cathode gas condensate separator (7) which is connected to the anode chamber via a condensate line and a pump (8) to form a water cooling cycle,
a reservoir with a reducing valve (9) for the produced oxygen, and
a controller/regulator unit (11) for the control/regulation of the oxygen generation, air supply and temperature of the PEM cell.

2. The oxygen generator of claim 1, wherein the anode is made of a metal of the platinum group, preferably iridium.

3. The oxygen generator of claim 1 and/or 2, wherein the cathode is made of a platinum group metal/carbon compound, the platinum group metal preferably being platinum.

4. The oxygen generator of at least one of the preceding claims, wherein a multitude of PEM cells are stacked and joined to a stack with regard to the gas guiding and water guiding as well as the power supply, the stacking being done in such a way that the cells are in electric contact with one another via bipolar plates and that the anode chambers and cathode chambers are sealed against each other by means of gasket frames.

5. A process for the production of oxygen using the oxygen generator described in the claims 1 to 4, the process comprising the steps of:
supplying/removing air to/from the cathode chambers of the PEM cell or the PEM stack,
withdrawing and removing produced oxygen from the anode chambers,
regulating the electric current through the PEM cell or the PEM stack with the pressure drop upon oxygen withdrawal by means of a programmable controller;
condensing water vapor out of the exhaust air from the cathode chambers of the PEM cell or the PEM stack, and
pumping the water vapor condensate after cooling, and supplying this condensate to the anode chamber of the PEM cell or the PEM stack.
